(19) United States
(12) Patent Application Publication
(10) Pub. No.: US 2021/0351403 A1
(43) Pub. Date: Nov. 11, 2021

(54) SECONDARY BATTERY

(71) Applicant: POWER IV, Inc., Tokyo (JP)

(72) Inventors: Junji NAKAJIMA, Tokyo (JP); Akimichi DEGAWA, Tokyo (JP)

(73) Assignee: POWER IV, Inc., Tokyo (JP)

(21) Appl. No.: 17/209,936

(22) Filed: Mar. 23, 2021

(30) Foreign Application Priority Data
Mar. 25, 2020 (JP) 2020-054610

(51) Int. Cl. H01M 4/48; H01M 4/38; H01M 4/583; H01M 4/04; H01M 10/0525

(52) U.S. Cl. CPC H01M 4/48; H01M 4/386; H01M 2004/021; H01M 4/0426; H01M 10/0525; H01M 4/583

(57) ABSTRACT

A secondary battery includes: a first electrode configured to function as a p-type semiconductor; a second electrode configured to function as an n-type semiconductor; and a hole transfer member provided between the first electrode and the second electrode, the first electrode is a sputtered film or a vapor deposited film, the second electrode is a sputtered film or a vapor deposited film containing at least one of silicon and graphene, and the hole transfer member is a sputtered film or a vapor deposited film containing a dielectric material.

### TECHNICAL FIELD

The present invention relates to a secondary battery.

### BACKGROUND ART

Currently, lithium ion secondary batteries are widely used. The lithium ion secondary batteries generally include a positive electrode that contains lithium-containing transition metal complex oxides as an active material, a negative electrode that contains, as an active material, a material that allows occlusion and release of lithium ions, a non-aqueous electrolyte, and a separator (for example, see JPH5-242911A).

In recent years, the secondary batteries are widely used for not only mobile electronic devices, but also, as stationary batteries, etc. such as those for an electric vehicle, a smart grid, a humanoid robot, a drone, an electric power load leveling system, and so forth. Thus, development of a high capacity/small sized secondary battery that has an input/output performance higher than that of the conventional lithium ion secondary batteries is expected.

### SUMMARY OF INVENTION

However, the conventional lithium ion secondary batteries have limitations in terms of output and capacity per unit weight. In addition, because the conventional lithium ion secondary batteries are electrochemical batteries, there is a limitation in terms of size reduction.

An object of the present invention is to provide a secondary battery that is capable of achieving the high input/output performance, the high capacity, and the size reduction.

According to an aspect of the present invention, a secondary battery includes: a first electrode configured to function as a p-type semiconductor; a second electrode configured to function as an n-type semiconductor; and a hole transfer member provided between the first electrode and the second electrode, the first electrode is a sputtered film or a vapor deposited film, the second electrode is a sputtered film or a vapor deposited film containing at least one of silicon and graphene, and the hole transfer member is a sputtered film or a vapor deposited film containing a dielectric material.

### BRIEF DESCRIPTION OF DRAWINGS

FIG. 1 is a schematic view of a secondary battery according to a first embodiment of the present invention.

FIG. 2 is a sectional view showing a state in which the secondary battery according to the first embodiment of the present invention is provided on an electronic substrate of an electronic device.

FIG. 3 is a sectional view showing a state in which the secondary battery according to the first embodiment of the present invention is provided on the electronic substrate of the electronic device.

FIG. 4 is a sectional view of the secondary battery according to a second embodiment of the present invention.

FIG. 5 is a sectional view of the secondary battery according to the second embodiment of the present invention.

### DESCRIPTION OF EMBODIMENTS

A secondary battery according to an embodiment of the present invention will be described below, with reference to the drawings.

### First Embodiment

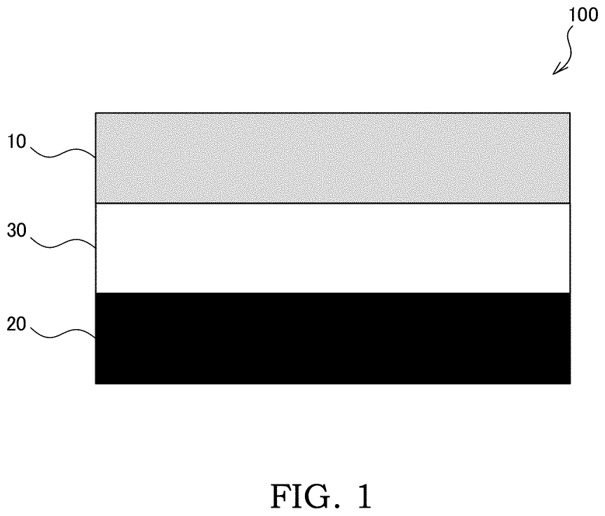

A secondary battery 100 according to a first embodiment of the present invention will be described with reference to FIGS. 1 to 3.

[Overall Configuration of Secondary Battery 100]

As shown in FIG. 1, the secondary battery 100 is provided with an electrode 10 serving as a first electrode that functions as a p-type semiconductor, an electrode 20 serving as a second electrode that functions as an n-type semiconductor, and a hole transfer member 30 provided between the electrode 10 and the electrode 20.

The electrode 10 functions as a positive electrode. The electrode 10 is a sputtered film or a vapor deposited film and contains nickel oxide, for example. The electrode 20 functions as a negative electrode. The electrode 20 is a sputtered film or a vapor deposited film containing at least one of silicon and graphene. The hole transfer member 30 is a sputtered film or a vapor deposited film containing a dielectric material, and for example, the hole transfer member 30 contains lithium niobate or silicon nitride. The electrode 10, the electrode 20, and the hole transfer member 30 are respectively formed as films so as to form flat planes and laminated. Because the electrode 10 and the electrode 20 are the sputtered films formed by a sputtering or the vapor deposited films formed by a vapor deposition, a binder is not contained. In other words, the electrode 10 and the electrode 20 are the sputtered films or the vapor deposited films that do not contain the binder. The electrode 10 and the electrode 20 face to each other via the hole transfer member 30 and do not come into physical contact.

The secondary battery 100 provided with the electrode 10 that functions as the p-type semiconductor, the electrode 20 that functions as the n-type semiconductor, and the hole transfer member 30 is charged/discharged by movement of the holes, but not by movement of the ions as in the case of a conventional lithium ion secondary battery. Specifically, when the secondary battery 100 is charged, a terminal of an external power source (not shown) with a higher electric potential is electrically connected to the electrode 10 and a terminal of the external power source with a lower potential is electrically connected to the electrode 20, and thereby, the holes are generated in the electrode 10. Furthermore, the holes in the electrode 10 move to the electrode 20 through the hole transfer member 30. When the secondary battery 100 is discharged, the electric potential in the electrode 10 is higher than the electric potential in the electrode 20, and due to this electric potential difference between the electrode 10 and the electrode 20, the holes in the electrode 10 move to the electrode 20 through an external load (not shown). In addition, the holes in the electrode 20 move to the electrode 10 through the hole transfer member 30. Thus, current flows from the electrode 10 to the electrode 20 through the external load (not shown).

In the above, the holes are smaller than the ions and has a higher movability. Because the secondary battery 100 is operated by the movement of the holes that is faster than the movement of the ions, the secondary battery 100 has a high rapid charge performance and a high input/output performance. In addition, it is conceived that, in a case in which the electrode 20 contains graphene, in the electrode 20 during the charging, the holes move in the direction perpendicular to the direction of electric field in the electrode 10, and the electrons are accumulated in the direction opposite from the holes. In the electrode 20 during the discharging, a dielectric polarization reaction is caused, and then, the electrons accumulated in the electrode 20 are discharged outside at once, and the holes in the electrode 20 move towards the electrode 10 side. Thus, the secondary battery 100 has the high output performance.

In addition, because chemical reactions are not occurred in the operation of the secondary battery 100, the secondary battery 100 has a long service life, a high capacity, the high input/output performance, the high rapid charge performance, and a high safety.

As described above, because the secondary battery 100 is operated by the movement of the holes, the battery can be said to be based on the principle of a semiconductor battery. Because the secondary battery 100 is operated by the movement of the holes but not of the ions, the secondary battery 100 has the high input/output performance and the high capacity.

In addition, the electrode 10, the electrode 20, and the hole transfer member 30 are the sputtered films or the vapor deposited films. In other words, the electrode 10 and the electrode 20 are not formed by kneading and applying materials, and so, it is possible to reduce steps for producing the electrode 10 and the electrode 20, and furthermore, it is possible to form excellent conductive paths to the electrode 10 and the electrode 20. In addition, because the binder for adhering the electrode active materials are not required for the electrode 10 and the electrode 20, the secondary battery 100 has the long service life, the high capacity, the high input/output performance, and the high rapid charge performance.

In addition, for the conventional lithium ion secondary battery, because the electrode 10 and the electrode 20 are formed by kneading and applying the materials, there is a limitation in terms of the size reduction of the electrode 10 and the electrode 20, and therefore, the size reduction of the battery is also limited. In contrast, the respective films forming the electrode 10, the electrode 20, and the hole transfer member 30 of the secondary battery 100 according to the first embodiment of the present invention are formed by the sputtering or the vapor deposition. Therefore, it is even possible to form the electrode 10, the electrode 20, and the hole transfer member 30 as small as, for example, 2 millimeters square with ease, and it is possible to make the secondary battery 100 smaller than the conventional lithium ion secondary battery. Thus, as described below, it is possible to make the secondary battery 100 as a small chip, and it becomes possible to provide the secondary battery 100 on an electronic substrate 51 of an electronic device 50.

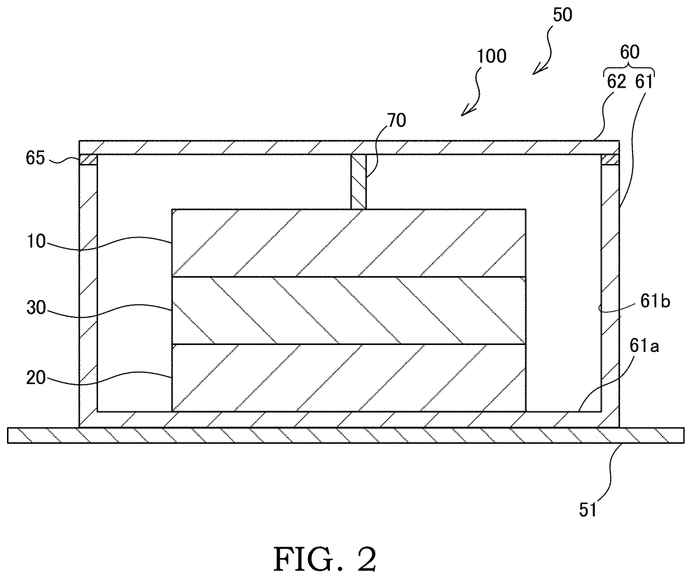

As shown in FIG. 2, the secondary battery 100 functions as a power source or an auxiliary power source of the electronic device 50 by being provided on the electronic substrate 51 of the electronic device 50. For example, the secondary battery 100 is provided on the electronic substrate 51 of a personal computer as the electronic device 50 and functions as the auxiliary power source. Thus, it is possible to retain a content of a volatile memory and to mitigate an impact to an electronic component when a power supply from a main power source is interrupted due to a power failure, etc. In addition, even when the main power source is off, the content of the volatile memory can be retained by supplying the power from the secondary battery 100 to the volatile memory. Furthermore, it is possible to provide the secondary battery 100 on the electronic substrate 51 of a pacemaker as the electronic device 50 and to allow the secondary battery 100 to function as the main power source. Because the operation of the secondary battery 100 does not occurred the chemical reaction, the high safety is achieved. Furthermore, the secondary battery 100 is not a non-rechargeable primary battery used for a conventional pacemaker and is the rechargeable secondary battery, and so, the secondary battery 100 is suitable as the main power source of the pacemaker.

It is preferable that the respective films forming the electrode 10, the electrode 20, and the hole transfer member 30 be provided on the electronic substrate 51 by being accommodated in a case 60. The case 60 is formed of a conductive material such as copper, for example. The case 60 has a main body portion 61 having a recessed shape and that is installed on the electronic substrate 51 and a lid portion 62 that closes an opening of the main body portion 61. An O-ring 65 serving as a seal member that is formed of an insulating body such as an insulating rubber is provided between the main body portion 61 and the lid portion 62, and thereby, an electrical connection between the main body portion 61 and the lid portion 62 is prevented.

The electrode 20 is formed on a bottom plate 61a of the main body portion 61 of the case 60 as a film, the hole transfer member 30 is formed on the electrode 20 as a film, and the electrode 10 is formed on the hole transfer member 30 as a film. The respective films forming the electrode 10, the electrode 20, and the hole transfer member 30 are formed by a method that uses a metal mask during the film formation, or a method that does not use the metal mask in which a lithography and an etching are performed after the film formation. The electrode 10 is electrically connected to the lid portion 62 of the case 60 via a conductive portion 70 formed of a lead wire, a wire, a conductive paste, or the like. Thus, the electrode 20 functioning as the negative electrode is electrically connected to the main body portion 61, and the electrode 10 functioning as the positive electrode is electrically connected to the lid portion 62. Because the main body portion 61 and the lid portion 62 of the case 60 are electrically connected to a circuit of the electronic substrate 51, the secondary battery 100 functions as the power source or the auxiliary power source of the electronic device 50.

As described above, because the electrode 10, the electrode 20, and the hole transfer member 30 are the sputtered films formed by the sputtering or the vapor deposited films formed by the vapor deposition, the secondary battery 100 is small and can be used as the power source or the auxiliary the power source by being provided on the electronic substrate 51 of the electronic device 50. In addition, because the electrode 10, the electrode 20, and the hole transfer member 30 do not occurred chemical change at the time of charging/discharging, unlike the conventional lithium ion secondary battery, expansion and shrinkage of the battery are not caused in the secondary battery 100, and it is possible to maintain its small chip-like shape. Furthermore, because the electrode 10, the electrode 20, and the hole transfer member 30 are accommodated in the case 60, deterioration of the secondary battery 100 by the heat from the electronic device 50 and occurrence of electric leakage when the electronic device 50 is submerged under water are prevented.

In the above, the electrode 10 may also be electrically connected to a side wall portion 61b of the main body portion 61 of the case 60 via the conductive portion 70. In this case, the electrical connection between the bottom plate 61a and the side wall portion 61b of the main body portion 61 may be prevented by providing an O-ring formed of the insulating body between the bottom plate 61a and the side wall portion 61b, for example.

In addition, the case 60 may be formed of insulating materials such as silica, for example. In this case, the electrode 10 and the electrode 20 may be electrically connected to the outside of the case 60 by, for example, forming a through hole in the case 60 and providing the conductive portion 70 in the through hole.

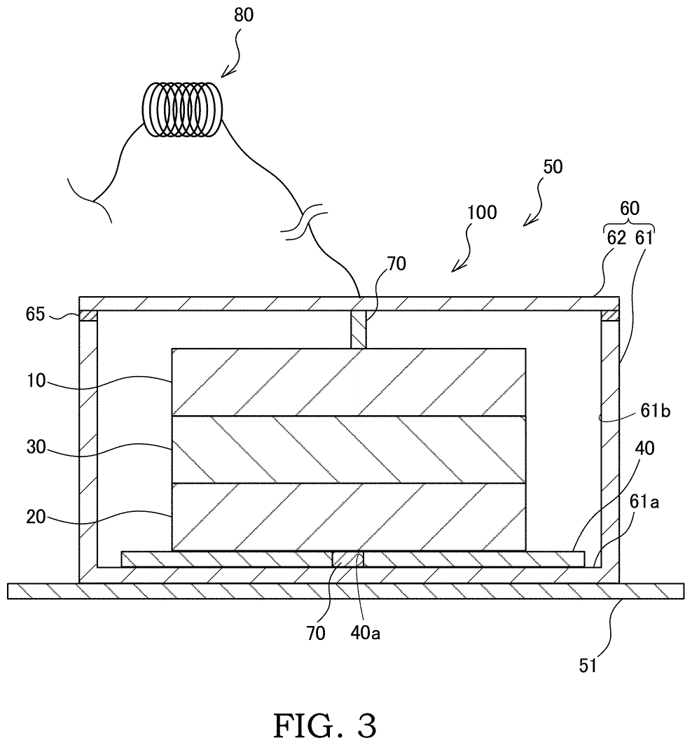

In addition, as shown in FIG. 3, the electrode 10, the electrode 20, and the hole transfer member 30 may be preformed as the films on a separate member 40, which is formed of the insulating materials such as silica, so as to form a single unit, and this unit may be accommodated in the case 60. Specifically, in the secondary battery 100, the member 40 is installed on the bottom plate 61a of the main body portion 61 of the case 60, thereby being accommodated in the case 60. It suffices that the electrode 20 is electrically connected to the main body portion 61 via the conductive portion 70 provided in a through hole 40a of the member 40. In the above, the member 40 may be formed of conductive materials. In this case, the through hole 40a of the member 40 and the conductive portion 70 are not required.

In addition, the secondary battery 100 may be provided on the electronic substrate 51 of the electronic device 50 without employing the case 60. In other words, the secondary battery 100 may be provided on the electronic substrate 51 of the electronic device 50 via the member 40 or may be provided directly on the electronic substrate 51 of the electronic device 50.

In addition, as shown in FIG. 3, the secondary battery 100 may further be provided with a wireless power supply coil 80 that is electrically connected to the electrode 10 and the electrode 20, and the power may be charged via the coil 80. With such a configuration, even in a state in which the secondary battery 100 is arranged on the electronic substrate 51 of the electronic device 50, the secondary battery 100 can be charged in a non-contact manner. Especially, in a case in which the secondary battery 100 is used as the main power source of the pacemaker, the secondary battery 100 can be charged by using the wireless power supply before occurrence of power depletion. Thus, because the secondary battery 100 serving as the main power source of the pacemaker is rechargeable by being the secondary battery, and at the same time, the secondary battery 100 can be charged by the wireless power supply, a replacement of the battery, which has conventionally been performed by a surgery, need not be performed anymore, and it is possible to use the secondary battery 100 semipermanently.

[Electrode 10]

The electrode 10 contains nickel oxide, for example. The electrode 10 is p-doped with antimony, etc., for example. Thus, the electrode 10 functions as the p-type semiconductor, and the holes are generated in the electrode 10. It is confirmed by a hole determination that an amount the holes relative to the metal ions is the greatest in nickel oxide among common positive electrode materials including manganese, cobalt, iron, and so forth. Therefore, by containing nickel oxide, more holes are contained in the electrode 10, and the performance of the secondary battery 100 is improved.

When nickel oxide is applied to the electrode 10, the sputtering is performed with the following conditions, for example.

Target: nickel oxide

Discharge gas: argon gas

Gas flow rate: 30 sccm

Gas pressure: 1.2×10⁻⁵ Pa

DC power: 100 W

Distance between target and substrate (TS distance): 40 mm

Treatment time: 140 min

Nickel oxide has a poor solubility, and it is difficult to perform patterning by wet etching. Thus, if the patterning is performed without using the metal mask, the lithography and the dry etching are performed after the film formation.

[Electrode 20]

The electrode 20 contains at least one of silicon and graphene. Silicon is, for example, SiOxa (xa<2). Graphene has a nano-level layered structure with at most ten layers. When the film formation of the electrode 20 containing graphene is performed, a part of graphene is coagulated to form graphite. Graphene may include carbon nanotubes. In addition, the electrode 20 may contain various types of natural graphite, synthetic graphite, a silicon-based composite material (such as silicide), a silicon oxide-based material, a titanium alloy-based material, and various types of alloy composition materials solely or in combination.

The electrode 20 is n-doped with, for example phosphorus oxide, sulfur oxide, arsenic, or the like. The doping of phosphorus oxide or sulfur oxide is performed by addition and dispersion by a high shear disperser, for example. Thus, the electrode 20 functions as the n-type semiconductor and is formed so as to allow the occlusion and release of the ions, the holes, and the electrons generated in the electrode 10. Here, the electrode 20 may be doped with other metal element. For example, alkali metal such as lithium, sodium, potassium and so forth, and a transition metal such as copper, titanium, zinc and so forth may also be doped.

Because it is difficult for silicon and graphene to function as a heat generating element, the generation of the heat tends not be caused even if an internal short circuit is caused in the secondary battery 100, and therefore, it is possible to improve the safety and the service life of the secondary battery 100. Especially, if the electrode 20 contains a mixture of silicon and graphene, it is possible to improve occlusion efficiency of the holes, and at the same time, it is possible to provide an electron accumulation layer.

When n-doped n-type silicon is applied to the electrode 20, for example, the sputtering is performed with the following conditions.

Target: n-type silicon

Discharge gas: argon gas

Gas flow rate: 30 sccm

Gas pressure: 1.7×10⁻⁵ Pa

DC power: 60 W

Distance between target and substrate (TS distance): 40 mm

Treatment time: 60 min

In addition, when graphene is applied to the electrode 20, for example, the sputtering is performed with the following conditions.

Target: graphene

Discharge gas: argon gas

Gas flow rate: 30 sccm

Gas pressure: 5.4×10⁻⁶ Pa

DC power: 70 W

Distance between target and substrate (TS distance): 40 mm

Treatment time: 80 min

In addition, when a mixture containing silicon and graphene is applied to the electrode 20, the sputtering is performed with the mixture as a target.

[Hole Transfer Member 30]

The hole transfer member 30 contains the dielectric material, preferably a ferroelectric material. The hole transfer member 30 contains, for example, lithium niobate or silicon nitride as the dielectric material. It is experimentally confirmed that lithium niobate and silicon nitride can be used under a high electric potential such as 10 V. In addition, a cost for lithium niobate and silicon nitride is lower than that of other dielectric materials. Thus, because the hole transfer member 30 contains lithium niobate or silicon nitride, the secondary battery 100 can be used under the high electric potential, and furthermore, the cost of the secondary battery 100 is reduced. In addition, the hole transfer member 30 may also contain the dielectric material such as sodium potassium niobate, bismuth ferrite, sodium niobate, bismuth titanate, sodium bismuth titanate, and so forth.

The holes are transported between the electrode 10 and the electrode 20 by the hole transfer member 30, and the physical contact between the electrode 10 and the electrode 20 is prevented. Thus, if the insulating body such as silica, etc. and a polymer such as an epoxy resin, etc. are used as the hole transfer member 30, for example, the holes cannot be moved between the electrode 10 and the electrode 20, and the secondary battery 100 cannot be operated. In addition, it is confirmed that if an acrylic resin having radicals are used as the hole transfer member 30, although the initial properties are obtained, the deterioration of the secondary battery 100 proceeds with the redox reactions and the service life thereof is shortened. The hole transfer member 30 is formed to have one or more layers.

When lithium niobate is applied to the hole transfer member 30, for example, the sputtering is performed with the following conditions.

Target: lithium niobate

Discharge gas: argon gas

Gas flow rate: 30 sccm

Gas pressure: 1.8×10⁻⁵ Pa

DC power: 60 W

Distance between target and substrate (TS distance): 50 mm

Treatment time: 50 min

In addition, when silicon nitride is applied to the hole transfer member 30, for example, a plasma CVD treatment is performed at substrate temperature of 300° C., and under pressure of 1.4×10⁻⁵ Pa in a vacuum chamber.

### Example

An example of the secondary battery 100 according to the first embodiment of the present invention will be described below. However, the present invention is not limited to the following example.

### Comparative Example

The conventional lithium ion secondary battery will be first mentioned for comparison.

The positive-electrode electrode material was prepared by stirring nickel manganese lithium cobaltate BC-618 from Sumitomo 3M Limited, PVDF #1320 from KUREHA CORPORATION (a solution in N-methyl pyrrolidone (NMP) at a solid content of 12 parts by weight), and acetylene black at a weight ratio of 3:1:0.09 together with additional N-methyl pyrrolidone (NMP) by using a twin-arm kneader. The positive-electrode electrode material was coated on an aluminum foil having a thickness of 13.3 μm. After dried, the aluminum foil was subjected to a rolling so as to have a total thickness of 155 μm, and subsequently, the aluminum foil was cut into a specific size to form a positive electrode.

On the other hand, the negative-electrode electrode material was prepared by stirring synthetic graphite, a styrene-butadiene copolymer rubber particle binder BM-400B from Zeon Corporation (solid content: 40 parts by weight), and carboxymethyl cellulose (CMC) at a weight ratio of 100:2.5:1 together with a suitable amount of water by using a twin-arm kneader. The negative-electrode electrode material was coated on a copper foil having a thickness of 10 μm. After dried, the copper foil was subjected to a rolling so as to have a total thickness of 180 μm, and subsequently, the copper foil was cut into a specific size to form a negative electrode.

A laminar structure was formed by interposing a polypropylene micro-porous film having a thickness of 20 μm as the separator between the positive electrode and the negative electrode, and the laminar structure was inserted into a battery casing can after cut into a predetermined size. An electrolyte was prepared by dissolving LiPF₆ (1M) in a mixed solvent formed by mixing ethylene carbonate (EC), dimethyl carbonate (DMC), and methyl ethyl carbonate (MEC). The electrolyte was injected into the battery casing can under a dry-air atmosphere and left it for a certain period. Subsequently, a preliminary charging was performed for about 20 minutes with an electric current equivalent to 0.1 C, and the battery casing can was sealed to form a stacked lithium ion secondary battery. Thereafter, an aging was performed by leaving the lithium ion secondary battery under a normal temperature environment for a certain period.

### Example

Next, the secondary battery 100 according to the first embodiment of the present invention will be described.

The sputtering target formed of the n-type silicon, the sputtering target containing lithium niobate, and the sputtering target containing nickel oxide are used for the film formation.

These sputtering targets were respectively attached to a sputtering device, and the electrode 20 containing the n-type silicon was formed as the film by the sputtering under the above-described conditions. Next, the hole transfer member 30 containing lithium niobate was formed as the film by the sputtering under the above-described conditions. Then, the electrode 10 containing nickel oxide was formed as the film by the sputtering under the above-described conditions. A volume ratio of the n-type silicon:lithium niobate:nickel oxide in the film was 5:3:10.

The batteries of the example and the comparative example produced as described above were evaluated by methods described below.

(Evaluation of Battery Initial Capacity)

A comparative performance evaluation of the capacity of the secondary battery was performed by setting 1 C discharged capacity in the specification electric potential range of 1 V to 3.8 V in the comparative example to 100. In addition, for the shape of the battery, a rectangular battery can was employed to obtain a laminated battery in this evaluation. Furthermore, a discharge capacity ratio of 10 C/1 C was measured. As a result, a high output performance was evaluated. Similarly, a charge capacity ratio of 10 C/1 C was measured. As a result, an input performance and a rapid charge performance were evaluated.

(Nail Penetration Test)

For a fully charged secondary battery, a state of heat generation and an appearance thereof were observed after the secondary battery was stabbed with an iron nail having a diameter of 2.7 mm to penetrate therethrough under a normal temperature environment at a speed of 5 mm/sec. The results are shown in Table 1 below. In Table 1, the secondary battery, in which no change was observed in the temperature and appearance of a secondary battery, is indicated as “OK”, and the secondary battery, in which a change was observed in the temperature and the appearance of the secondary battery, is indicated as “NG”.

(Overcharge Test)

The current was maintained at a charge rate of 200%, and it was determined whether or not a change in the appearance was caused for a period of more than 15 minutes. The results are shown in Table 1 below. In Table 1, the secondary battery in which an abnormality was not caused is indicated as “OK”, and the secondary battery in which a change (swollen, explosion, or the like) was caused is indicated as “NG”.

(Normal Temperature Service Life Characteristic)

The secondary batteries in the example and the comparative example (the specification electric potential range of 1 V to 3.8 V) were subjected to, at 25° C., a cycle of charging at 1 C/3.8 V and discharging at 1 C/1 V for 3,000 cycles and 10,000 cycles. Decrease in the capacity was compared with the initial capacity.

(Evaluation Results)

Table 1 shows the results of the evaluation described above.

TABLE 1

| | | | | | | 3000 cycle | 10000 cycle | | |
|---|---|---|---|---|---|---|---|---|---|
| | Capacity | | | | | service life | service life | | |
| | ratio at | Capacity | Capacity | 10 C/1 C | 10 C/1 C | test | test | SAFETY TEST | |
| | 1 C | (1 C) | (1 C) | discharge | charge | (capacity | (capacity | | Nail |
| | discharge | [mAh/g] | [mAh/g] | capacity | capacity | retaining | retaining | | penetration |
| | rate | 2-4.3 V | 2-4.6 V | ratio | ratio | ratio) [%] | ratio) [%] | Overcharge | test |
| Comparative | 100 | 168 | NG | 0.04 | 0.03 | 58 | 0 | NG | NG |
| Example | | | deteriorated | | | | | | |
| Example | 368 | 618 | 694 | 0.92 | 0.93 | 99 | 96 | OK | OK |

As described above, because the secondary battery 100 can be charged even under the high rate charging, the rapid charging can be performed. In addition, it is indicated that, because good discharging performance is achieved under high C rate, high output can be achieved.

### Second Embodiment

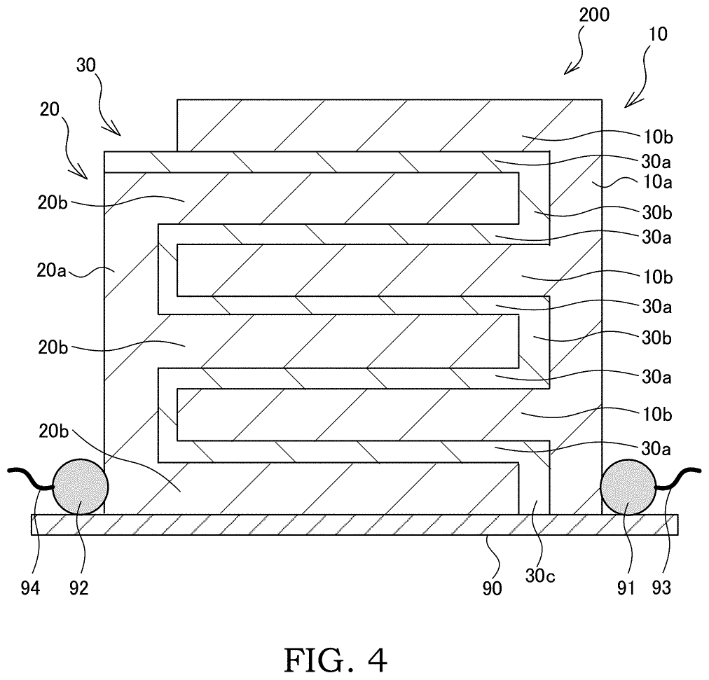

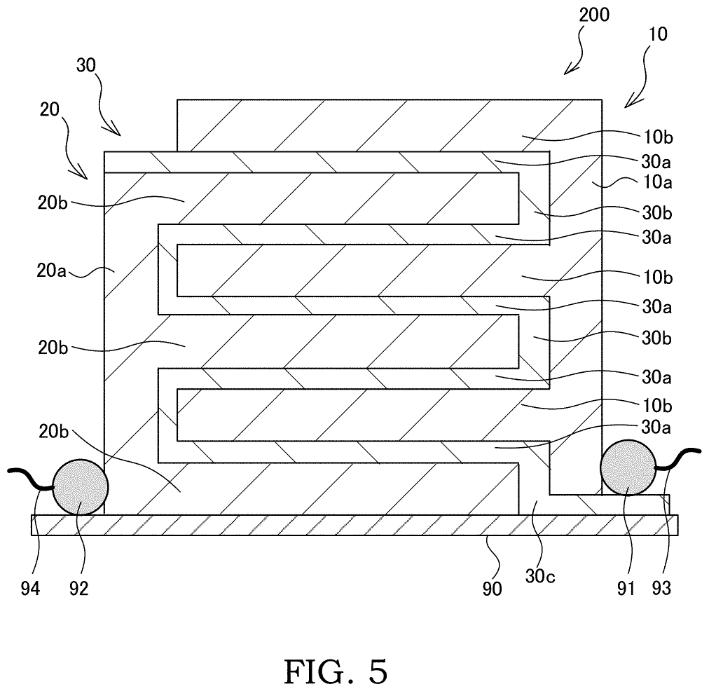

A secondary battery 200 according to a second embodiment of the present invention will be described with reference to FIGS. 4 and 5. FIGS. 4 and 5 are sectional views of the secondary battery 200. In the following, differences from the above-described first embodiment will be mainly described, and in the figures, components that are the same as or correspond to the components described in the above-described first embodiment are assigned the same reference numerals and description thereof will be omitted.

In the above-described first embodiment, the electrode 10, the electrode 20, and the hole transfer member 30 are formed as the films so as to form the flat planes. In contrast, in this second embodiment, the films forming the electrode 10 and the electrode 20 are respectively formed to have comb-teeth shapes so as to face with each other via the hole transfer member 30.

As shown in FIG. 4, specifically, the electrode 10, the electrode 20, and the hole transfer member 30 are formed on a substrate 90, and the films forming the electrode 10 and the electrode 20 respectively have base portions 10a and 20a that respectively extend perpendicularly to the substrate 90 and a plurality of comb tooth portions 10b and 20b that respectively extend in parallel with the substrate 90 from the base portions 10a and 20a. The respective comb tooth portions 10b and 20b of the electrode 10 and the electrode 20 are arranged alternately with each other. The hole transfer member 30 is formed so as to extend continuously between the electrode 10 and the electrode 20. Specifically, the hole transfer member 30 has a plurality of layer portions 30a that are formed between the comb tooth portions 10b of the electrode 10 and the comb tooth portions 20b of the electrode 20 adjacent with each other so as to extend in parallel with the substrate 90, connecting portions 30b that connect the adjacent layer portions 30a, and a substrate connecting portion 30c that connect the substrate 90 and the layer portions 30a closest to the substrate 90. By providing the hole transfer member 30, the electrical connection between the electrode 10 and the electrode 20 is prevented. The substrate 90 is the insulating body formed of, for example, silica, etc. The electrode 10 and the electrode 20 are electrically connected to an external electrical circuit by conductive paste 91 and 92 formed of silver, etc. and lead wires 93 and 94, for example.

The electrode 10, the electrode 20, and the hole transfer member 30 are formed as the films by, for example, laminating the respective films in an order from the substrate 90 side by the sputtering by using the metal mask. Instead, the film formation may be performed by utilizing the lithography and the etching. Specifically, the electrode 20 may be formed by the sputtering using a die, a resist may be formed on the electrode 20 by the lithography, and the electrode 10 may be formed on the resist by the sputtering, and thereafter, the resist may be removed by the etching, and the hole transfer member 30 may be formed between the electrode 20 and the electrode 10 by the sputtering.

As described above, in the secondary battery 200, the electrode 10 and the electrode 20 are formed to have the comb-teeth shape so as to face with each other, and therefore, an electrode area per unit volume is increased, and the secondary battery 200 has the high input/output performance and the high capacity. In addition, because the electrode 10, the electrode 20, and the hole transfer member 30 are the sputtered films or the vapor deposited films, the lengths of the base portions 10a and 20a and the number of comb tooth portions 10b and 20b of the electrode 10 and the electrode 20 can be changed with ease, and it is possible to easily change the capacity of the secondary battery 200.

In the above, the substrate 90 may be formed of, for example, a conductive body such as the n-doped n-type silicon, etc. In this case, for example, as shown in FIG. 5, it suffices that the film formation is performed such that the electrode 10 does not come into electrical contact with the substrate 90 by providing the hole transfer member 30.

In addition, similarly to the secondary battery 100 according to the first embodiment, the secondary battery 200 may also function as the power source or the auxiliary power source of the electronic device 50 by being provided on the electronic substrate 51 of the electronic device 50. In other words, the substrate 90 may be the electronic substrate 51. In addition, similarly to the secondary battery 100, the secondary battery 200 may be accommodated in the case 60. In other words, the substrate 90 may be the bottom plate 61a of the main body portion 61 of the case 60, or the member 40.

In addition, the electrode 10, the electrode 20, and the hole transfer member 30 may also be formed by the vapor deposition.

The configurations, operations, and effects of the embodiments of the present invention configured as described above will be collectively described.

The secondary battery 100, 200 is provided with: the electrode 10 configured to function as the p-type semiconductor; the electrode 20 configured to function as the n-type semiconductor; and the hole transfer member 30 provided between the electrode 10 and the electrode 20, wherein the electrode 10 is the sputtered film or the vapor deposited film, the electrode 20 is the sputtered film or the vapor deposited film containing at least one of silicon, graphene and graphite, and the hole transfer member 30 is the sputtered film or the vapor deposited film containing the dielectric material.

With this configuration, because the secondary battery 100, 200 is operated by the movement of the holes but not of the ions, the secondary battery 100, 200 has the high input/output performance and the high capacity. In addition, because the electrode 10, the electrode 20, and the hole transfer member 30 are each the sputtered film or the vapor deposited film, it is possible to reduce the size of the secondary battery 100, 200.

The electrode 10 contains nickel oxide.

With this configuration, because the amount of the holes relative to the metal ions is the greatest in nickel oxide among common positive electrode materials, the property of the secondary battery 100 is improved.

The hole transfer member 30 is characterized in that it contains lithium niobate or silicon nitride.

With this configuration, because lithium niobate and silicon nitride can be used under the higher electric potential such as 10 V, and in addition, the costs thereof are lower than that of other dielectric materials, it is possible to use the secondary battery 100 under the higher electric potential, and furthermore, the cost of the secondary battery 100 is reduced.

The secondary battery 100, 200 is provided on the electronic substrate 51 of the electronic device 50, the secondary battery 100, 200 being configured to function as the power source or the auxiliary power source of the electronic device 50.

With this configuration, because the secondary battery 100, 200 has a small size, it is possible to arrange the secondary battery 100, 200 on the electronic substrate 51 and use it as the power source or the auxiliary power source.

The respective films forming the electrode 10, the electrode 20, and the hole transfer member 30 are provided on the electronic substrate 51 by being accommodated in the case 60.

With this configuration, because the electrode 10, the electrode 20, and the hole transfer member 30 are accommodated in the case 60, the deterioration of the secondary battery 100, 200 due to the heat from the electronic device 50 and the electric leakage when the electronic device 50 is submerged under water are prevented.

The secondary battery 100, 200 further includes the wireless power supply coil 80 electrically connected to the electrode 10 and the electrode 20, wherein the secondary battery 100, 200 can be charged with the electrical power via the coil 80.

With this configuration, because the secondary battery 100, 200 includes the wireless power supply coil 80, the secondary battery 100, 200 can be charged in the non-contact manner even in a state in which the secondary battery 100, 200 is arranged on the electronic substrate 51 of the electronic device 50.

In the secondary battery 200, the respective films forming the electrode 10 and the electrode 20 are formed to have the comb-teeth shapes so as to face with each other via the hole transfer member 30.

In the secondary battery 200, the electrode 10, the electrode 20, and the hole transfer member 30 are formed on the substrate 90, the film forming each of the electrode 10 and the electrode 20 has the base portions 10a and 20a extending perpendicular to the substrate 90 and the plurality of comb tooth portions 10b and 20b extending in parallel with the substrate 90 from the base portions 10a and 20a, the respective comb tooth portions 10b and 20b of the electrode 10 and the electrode 20 are arranged alternately, and the hole transfer member 30 is formed so as to extend continuously between the electrode 10 and the electrode 20.

With this configuration, because the electrode 10 and the electrode 20 have the comb-teeth shapes so as to face with each other, the electrode area per unit volume is increased, and the secondary battery 200 has the high input/output performance and the high capacity. In addition, because the electrode 10, the electrode 20, and the hole transfer member 30 are the sputtered films or the vapor deposited films, it is easy to change the lengths of the base portions 10a and 20a and the number of the comb tooth portions 10b and 20b of the electrode 10 and the electrode 20, and it is also easy to change the capacity of the secondary battery 200.

Embodiments of this invention were described above, but the above embodiments are merely examples of applications of this invention, and the technical scope of this invention is not limited to the specific constitutions of the above embodiments.

This application claims priority based on Japanese Patent Application No. 2020-54610 filed with the Japan Patent Office on Mar. 25, 2020, the entire contents of which are incorporated into this specification.

1. A secondary battery comprising:
a first electrode configured to function as a p-type semiconductor;
a second electrode configured to function as an n-type semiconductor; and
a hole transfer member provided between the first electrode and the second electrode, wherein
the first electrode is a sputtered film or a vapor deposited film,
the second electrode is a sputtered film or a vapor deposited film containing at least one of silicon and graphene, and
the hole transfer member is a sputtered film or a vapor deposited film containing a dielectric material.

2. The secondary battery according to claim 1, wherein
the first electrode contains nickel oxide.

3. The secondary battery according to claim 1, wherein
the hole transfer member contains lithium niobate or silicon nitride.

4. The secondary battery according to claim 1, wherein
the secondary battery is provided on an electronic substrate of an electronic device, the secondary battery being configured to function as a power source or an auxiliary power source of the electronic device.

5. The secondary battery according to claim 4, wherein
the respective films forming the first electrode, the second electrode, and the hole transfer member are provided on the electronic substrate by being accommodated in a case.

6. The secondary battery according to claim 4, further comprising
a wireless power supply coil electrically connected to the first electrode and the second electrode, wherein the secondary battery can be charged with electrical power via the coil.

7. The secondary battery according to claim 1, wherein
the respective films forming the first electrode and the second electrode are formed to have a comb-teeth shapes so as to face with each other via the hole transfer member.

8. The secondary battery according to claim 7, wherein
the first electrode, the second electrode, and the hole transfer member are formed on a substrate,
the film forming each of the first electrode and the second electrode has a base portion extending perpendicular to the substrate and a plurality of comb tooth portions extending in parallel with the substrate from the base portion,
the respective comb tooth portions of the first electrode and the second electrode are arranged alternately, and
the hole transfer member is formed so as to extend continuously between the first electrode and the second electrode.
